(19) United States
(12) Patent Application Publication
(10) Pub. No.: US 2018/0270580 A1
(43) Pub. Date: Sep. 20, 2018

(54) VOICE COIL AND MINIATURE LOUDSPEAKER PROVIDED WITH THE VOICE COIL

(71) Applicant: Goertek Inc., Shandong (CN)

(72) Inventors: Qizhong Wang, Shandong (CN); Minghui Shao, Shandong (CN)

(21) Appl. No.: 15/758,415

(22) PCT Filed: May 6, 2016
(86) PCT No.: PCT/CN2016/081248

§ 371 Date: Mar. 8, 2018

(30) Foreign Application Priority Data
Mar. 31, 2016 (CN) 201610197238.7

(51) Int. Cl. H04R 9/02; H04R 9/06

(52) U.S. Cl. CPC H04R 9/025; H04R 9/06

(57) ABSTRACT

A voice coil and a miniature loudspeaker provided with the voice coil, which relate to the technical field of electro-acoustic products. The voice coil is formed by winding a wire. The number of wound layers of the wire is an even number. There is a height difference between a starting outgoing line position of the wire located at the innermost layer and a tail outgoing line position of the wire located at the outermost layer; and the height difference is less than 1.5 times the diameter of the wire. The voice coil and the miniature loudspeaker provided with the voice coil of the present invention solve the technical problem in the prior art that a voice coil breaks easily when working under large displacement. A voice coil lead of the voice coil and the miniature loudspeaker provided with the voice coil of the present invention is not easily broken and highly reliable, has a long service life, and can be suitable for a developmental tendency of miniature loudspeaker products.

### CROSS-REFERENCE TO RELATED APPLICATIONS

This application is a National Stage of International Application No. PCT/CN2016/081248, filed on May 6, 2016, which claims priority to Chinese Patent Application No. 201610197238.7, filed on Mar. 31, 2016, both of which are hereby incorporated by reference in their entireties.

### BACKGROUND

### Technical Field

The present invention relates to the field of electroacoustic products, and in particular, to a voice coil and a miniature loudspeaker provided with the voice coil.

### Description Of Related Art

As an important acoustic component in portable electronic devices, a miniature loudspeaker is used for converting an electrical acoustic wave signal into a sound signal for transmission out and thus is an energy conversion device. The miniature loudspeaker generally comprises a vibration system and a magnetic circuit system, wherein the vibration system comprises a vibration diaphragm and a voice coil, which are coupled together, and the voice coil is a driving component of the miniature loudspeaker. When an alternating audio current passes through the voice coil, the voice coil generates a magnetic field which changes along with the audio current. The changed magnetic field attracts or repulses a magnetic field of the magnetic circuit system of the miniature loudspeaker, so that the voice coil generates a mechanical vibration for cutting magnetic flux lines, thereby driving the vibration diaphragm to vibrate to emit a sound. The voice coil is formed by winding a wire, and a start end and a tail end of the wire are respectively led out as voice coil leads for being electrically connected to a circuit. The problem of wire breakage of the voice coil lead will occur as the vibration displacement of the miniature loudspeaker becomes larger, particularly after a large displacement reliability test. The voice coil of the miniature loudspeaker will works under large displacements due to stricter conditions of the large displacement reliability test and population of Smart PAs (power amplifiers). Thus, there is an urgent need for a technical solution which can solve the technical problem of high possibility of wire breakage when the voice coil works under large displacements so as to improve the reliability and prolong the service life of the miniature loudspeaker and adapt to the development trend of miniature loudspeaker products.

### BRIEF SUMMARY

With regard to the above defect, the first technical problem to be solved by the present invention is to provide a voice coil which is high in reliability and low in possibility of breakage of voice coil leads thereof, and thus can work under large displacements.

Based on the same inventive concept, the second technical problem to be solved by the present invention is to provide a miniature loudspeaker which is high in reliability, is long in service life because voice coil leads are unlikely to break, and thus can adapt to the development trend of miniature loudspeaker products.

To solve the first technical problem described above, the technical solution of the present invention is as below.

A voice coil formed by winding even-numbered layers of wires is provided, wherein there is a height difference between a start position of the wire at the innermost layer and an end position of the wire at the outermost layer, and the height difference is no greater than 1.5 times of the diameter of the wire.

As an embodiment, the height difference is 1.5 times of the diameter of the wire.

As another embodiment, the height difference is 0.5 time of the diameter of the wire.

To solve the second technical problem described above, the technical solution of the present invention is as below.

A miniature loudspeaker comprising a vibration system and a magnetic circuit system is provided, wherein the vibration system comprises a vibration diaphragm and a voice coil which are coupled together, and the voice coil is the voice coil described above.

After adoption of the technical solutions described above, the present invention has the following beneficial effects.

The voice coil of the present invention is formed by winding a wire, there is a height difference between a start position of the wire at the innermost layer and an end position of the wire at the outermost layer, and the height difference is no greater than 1.5 times of the diameter of the wire. In view of reliability and wire breakage, the smaller the height difference between the start position and the end position is, the longer the tail end lead is, which can effectively reduce stress received at a wire lead-out position, and therefore the defect of wire breakage of the tail end lead due to fatigue can be mitigated to a large extent. Thus, the probability of wire breakage of the voice coil lead is effectively reduced during working under large displacements, the reliability of the voice coil is improved and thus the voice coil can adapt to working under large displacements. Furthermore, the small height difference between the start position and the end position further facilitates reinforcing design at the wire lead-out position, which further reduces the stress received at the wire lead-out position and thus further reduces the probability of wire breakage of the voice coil lead.

By adopting the voice coil described above, the miniature loudspeaker of the present invention is high in reliability, is long in service life because the voice coil leads are unlikely to break and thus can adapt to the development trend of miniature loudspeaker products.

In summary, the voice coil and the miniature loudspeaker having the same of the present invention solve the technical problem of high possibility of wire breakage of the voice coil when the voice coil works under large displacement in the prior art. The voice coil and the miniature loudspeaker having the same of the present invention are high in reliability, are long in service life because the voice coil leads are unlikely to break, and thus can adapt to the development trend of miniature loudspeaker products.

### BRIEF DESCRIPTION OF THE FIGURES

FIG. 1 is a schematic structural view of the voice coil of the present invention;

FIG. 2 is a structural schematic sectional view along the line A-A or B-B of FIG. 1; and

FIG. 3 is another structural schematic sectional view along the line A-A or B-B of FIG. 1. In the figures, the reference signs represent the following components: 10: body; 100: end bonded to the vibration diaphragm; 102: start and tail ends; 104: wire; 12: start end lead; 14: tail end lead; d: the diameter of the wire; and a; a′: the height difference between the start line and end line positions.

### DETAILED DESCRIPTION OF THE VARIOUS EMBODIMENTS

The present invention will be further described with reference to the drawings and embodiments.

### Embodiment One

As shown in FIG. 1, there is provided a voice coil comprising a body 10 formed by winding even-numbered layers, usually two or four layers, of wires. One end of the body 10 of the voice coil is bonded to a vibration diaphragm, and the other end thereof is a wire lead-out end. The voice coil is wound from an inner layer to an outer layer during winding. A start end lead 12 of the voice coil is led out from a start end of the innermost layer, and a tail end lead 14 of the voice coil is led out from a tail end of the outermost layer. Both the start end lead 12 and the tail end lead 14 are located at the end, away from the vibration diaphragm, of the body 10 of the voice coil, since even-numbered layers of wire are wound. In this embodiment, it requires a height difference between a start position of the wire at the innermost layer and an end position of the wire at the outermost layer, and the height difference shall not be greater than 1.5 times of the diameter of the wire.

The technical solution described above is further described in the following by taking the voice coil formed by winding two layers of wires each having 32 turns as an example:

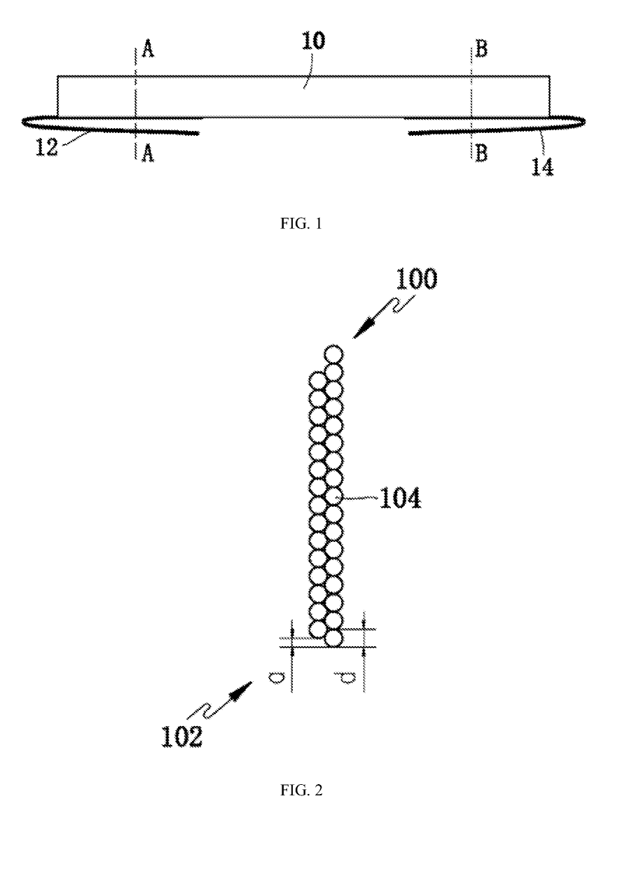

As shown in FIG. 2, the voice coil is formed by winding a wire 104 by 32 turns with 17 turns on a first layer (the innermost layer) and 15 turns on a second layer (the outermost layer). An upper end is an end 100 bonded to the vibration diaphragm, a lower end is a start and tail wire lead-out end, the diameter of the wire is defined as d, and thus the height difference a between the start line and end line positions is 0.5d. That is, the height difference between a start position of the wire at the innermost layer and an end position of the wire at the outermost layer is 0.5 time of the diameter 104 of the wire.

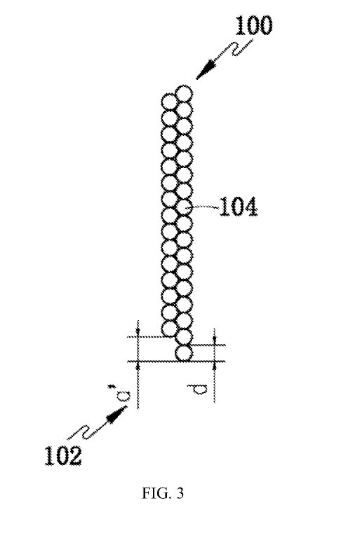

As shown in FIG. 3, in another winding mode of the voice coil described above, the height difference a′ between the start line and end line positions is 1.5d. That is, the height difference between a start position of the wire at the innermost layer and an end position of the wire at the outermost layer is 1.5 times of the diameter 104 of the wire.

By means of the solution described above of controlling the height difference between the start line and end line positions within 1.5 times of the diameter of the wire, the defect of wire breakage of the tail end lead due to fatigue can be mitigated to a large extent. Thus, the probability of wire breakage of the voice coil lead is effectively reduced during working under large displacements, the reliability of the voice coil is improved and the voice coil thus can adapt to working under large displacements.

### Embodiment Two

A miniature loudspeaker comprising a vibration system and a magnetic circuit system is provided, wherein the vibration system comprises a vibration diaphragm and a voice coil which are coupled together. The voice coil is the voice coil described in Embodiment One.

By means of adopting the voice coil described in Embodiment One, the speaker of the present invention is high in reliability, is long in service life because the voice coil leads are unlikely to break, and thus can adapt to the development trend of increasing vibration displacements of miniature loudspeaker products.

The present invention is not limited to the specific embodiments described above, and various variations made by persons of ordinary skill in the art based on the concept described above without creative efforts all fall within the protection scope of the present invention.

1-4. (canceled)

5. A voice coil formed by winding even-numbered layers of wire, wherein there is a height difference between a start position of a wire at the innermost layer and an end position of the wire at the outermost layer, and the height difference is less than 1.5 times of the diameter of the wire.

6. The voice coil according to claim 1, wherein the height difference is 1.5 times of the diameter of the wire.

7. The voice coil according to claim 1, wherein the height difference is 0.5 time of the diameter of the wire.

8. A miniature loudspeaker comprising:
a vibration system and a magnetic circuit system, wherein the vibration system comprises:
a vibration diaphragm, and
a voice coil coupled together with the vibration diaphragm, wherein the voice coil is formed by winding even-numbered layers of wire, wherein there is a height difference between a start position of a wire at the innermost layer and an end position of the wire at the outermost layer, and the height difference is less than 1.5 times of the diameter of the wire.
